(19) United States
(12) Patent Application Publication
(10) Pub. No.: US 2013/0020762 A1
(43) Pub. Date: Jan. 24, 2013

(54) Honesty The Best Strategy Game

(71) Applicant: Garth Hope Taylor, Miramar, FL (US)

(72) Inventor: Garth Hope Taylor, Miramar, FL (US)

(21) Appl. No.: 13/189,536

(22) Filed: Jul. 24, 2011

(51) Int. Cl. A63F 3/00; G09B 19/22

(52) U.S. Cl. 273/243; 434/128

(57) ABSTRACT

A question and answer board game to be played by at least two players having a game board, two dice, a timing device, a plurality of place markers, a plurality of question cards having questions, each question having a plurality of potential answers, one of which is correct, a card with answers and a plurality of answer tokens used to indicate a player's chosen answer or answers. The game tests a player's general knowledge or a player's knowledge of specific topics and rewards correct answers with points and bonus points in accordance with the rules of the game. The particular topic for each game is determined by the set of question cards chosen to play the game. The game rules encourage interaction among players and strategic play by allowing players to benefit from providing two answers to questions, one an honest answer and the second a strategic answer.

### CROSS-REFERENCED TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to a board game, and more particularly, to a question and answer educational and entertaining board game in which strategic playing is a feature of the game.

2. Description of Prior Art

Many board games exist which test a player's knowledge of various subject areas and general knowledge and allow players to gain points by providing correct answers. A need is identified for an educational and entertaining board game where as in real life players must not only provide answers but must assess answers received from other players using whatever information is available as well as their best judgement and then determine the best strategy to maximize the benefit accruing to themselves before playing. The game employs the method of an honest answer and a helping answer, the possession of the former when correct is a necessary condition for receiving any points and this requirement establishes what the player believes to be a genuine or honest answer and allows any deviant helping answer to be assessed for its true purpose, at the end of the round when the answer card is consulted. The use of an honest answer and a helping answer for which there is no known precedent allows for significant interaction among the players which contributes to the game's entertainment value.

### SUMMARY OF THE INVENTION

It is therefore an object of the present invention to provide a question and answer board game which can be used to test a player's knowledge of any topic or a player's general knowledge, in an entertaining manner and also be educational while promoting stimulation by allowing for significant interaction among players based on the answers they provide.

Another object of the present invention is to provide a question and answer board game which will continue to be challenging after regular play and will not easily allow for memorization of the answers without understanding the subject area.

A further object of the present invention is to provide a question and answer board game which encourages players to be creative, to take bold risks and to strategize.

According to the present invention, a question and answer board game is provided for at least two players and includes a board having a plurality of sequenced spaces indicated thereon, dice, a timing device, a plurality of place markers, a plurality of question cards, an answer card and a plurality of answer tokens used to indicate a player's chosen answer or answers.

In accordance with the invention in the course of play, players answer questions chosen at random by throw of dice and each player commencing at the start space advances his place marker along the playing path a number of sequential spaces on the perimeter of the board, the number being determined by points gained for correct answers in accordance with the game rules.

The game requires players to take turns being a leader who has the option to refuse help from players. Players must always provide help and become helpers unless the leader refuses help. Players must provide two answers described in the game rules as an honest answer and a helping answer. Bonus points are awarded to a helper or a leader in accordance with the game rules, based on three of five possible outcomes. The five possible outcomes are as follows: (i) the leader accepts the help by being able to identify the helping answer as correct and proffering that correct answer as the honest answer; (ii) the leader refuses the help by being unable to identify the helping answer as correct and proffering an incorrect answer as the honest answer; (iii) the leader refuses the help by being able to identify the helping answer as incorrect and being able to proffer the correct answer instead; (iv) the leader is misled and proffers the same incorrect answer as the helping answer; and (v) the leader proffers an incorrect answer which is different from the incorrect helping answer.

The five outcomes identified above are named ‘Honest Abe’, ‘Suspicious Sam’, Catch a Trickster’ ‘We Was Tricked’ and ‘We Didn't Know’ respectively and the names are also used to identify sequential spaces on the board. A player whose place marker is located on a space named after an identified outcome gains double points if the outcome is achieved while the place marker is located there. The game also requires in accordance with the game rules for a leader to propose an answer before other players provide their answers. Bonus points are awarded to the leader or each other player in accordance with the game rules, based on whether one or the other, but not both, provides the correct answer. The game also allows in accordance with the game rules for the option of a multiplier to be gained by a leader before questions are asked. Once gained, the multiplier doubles the points received by each player during the round.

As used herein the expression “game board” or “board” used is to be given a broad meaning and includes all materials and items on which a game can be played. Thus the expression is not limited to a board per se, and includes electronic versions of the game projected onto a screen and electronic versions of the game presented on an electronic viewing device such as a monitor.

### BRIEF DESCRIPTION OF THE DRAWINGS

FIG. 1 is a plan view of the game board of the present invention;

FIG. 2 is a plan view of an exemplary question card for use with the game of FIG. 1;

FIG. 3 is a plan view of an exemplary question card for use with the game of FIG. 1;

FIG. 4 is a plan view of an exemplary question card for use with the game of FIG. 1;

FIG. 5 is a plan view of an exemplary question card for use with the game of FIG. 1; and

FIG. 6 is a plan view of an exemplary answer cards for use with the game of FIG. 1

### DETAILED DESCRIPTION OF THE INVENTION

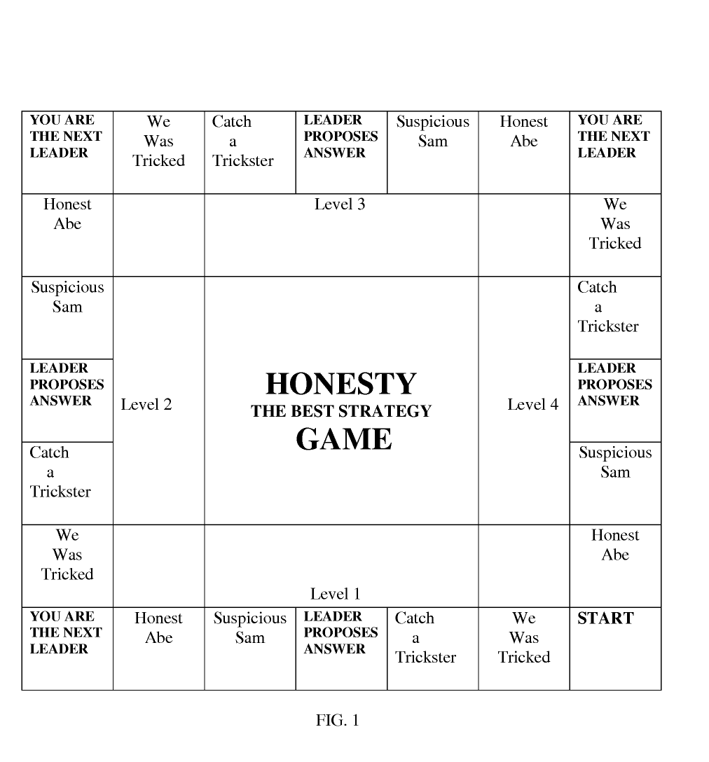

The question and answer game of this invention allows for a player to win the game by being the first player to complete a circuit of the game board illustrated at FIG. 1, in accordance with the rules of the game, starting at the space identified as start.

The game is suitable for two or more players. The game apparatus includes a game board illustrated at FIG. 1, two dice with six facets, each facet having one to six spots, a timing device capable of measuring seconds, question cards each card including eleven questions and each question having four potential answers identified as A, B, C or D and one answer reference located below each question, at least one answer card having indicia in the form of a matrix with ten rows and eleven columns forming one hundred and ten cells which contain answers and dummy answers identified as A, B, C or D, answer tokens with labels A, B, C or D, corresponding to the choice of potential answers on the question cards, place markers of different shapes or colors, one being assigned to each player and a rule booklet containing instructions for playing the game.

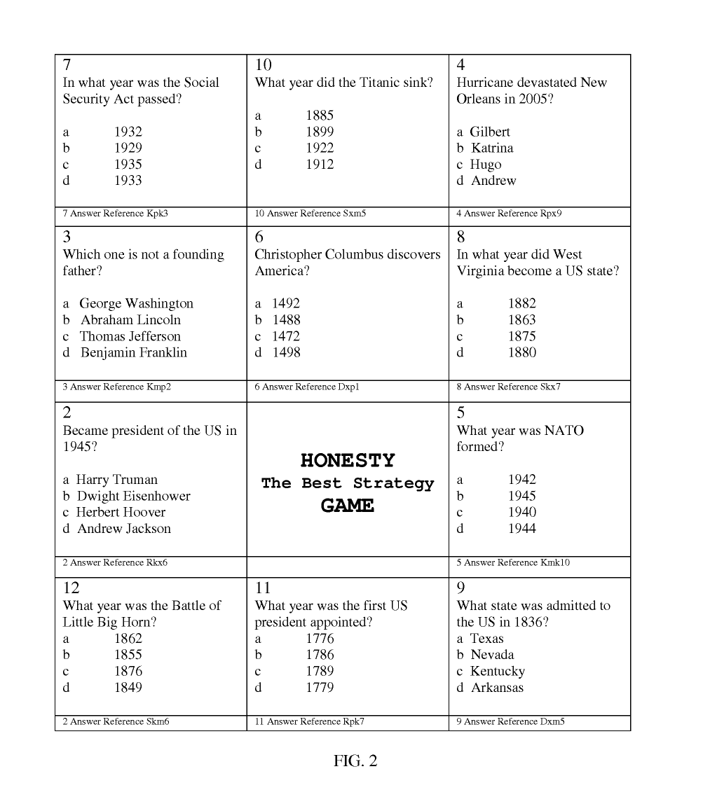

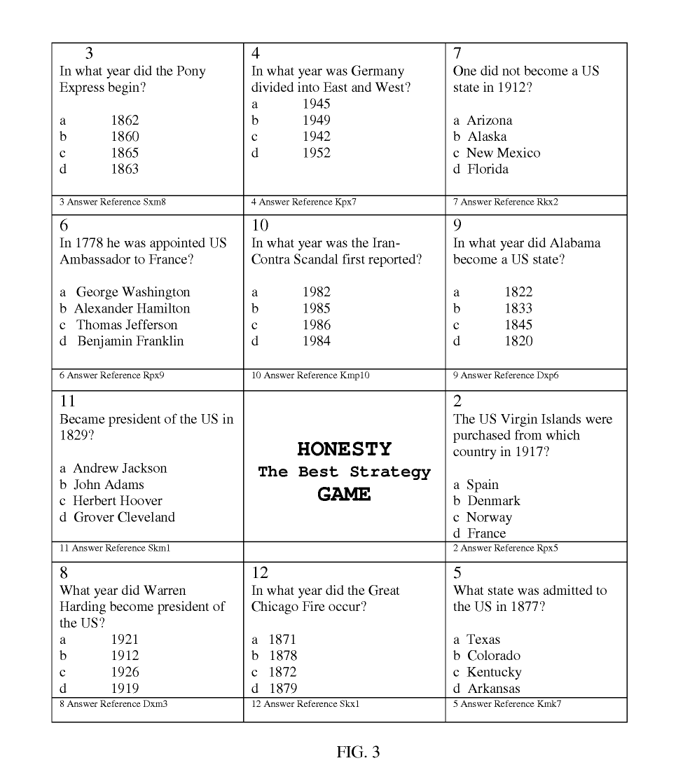

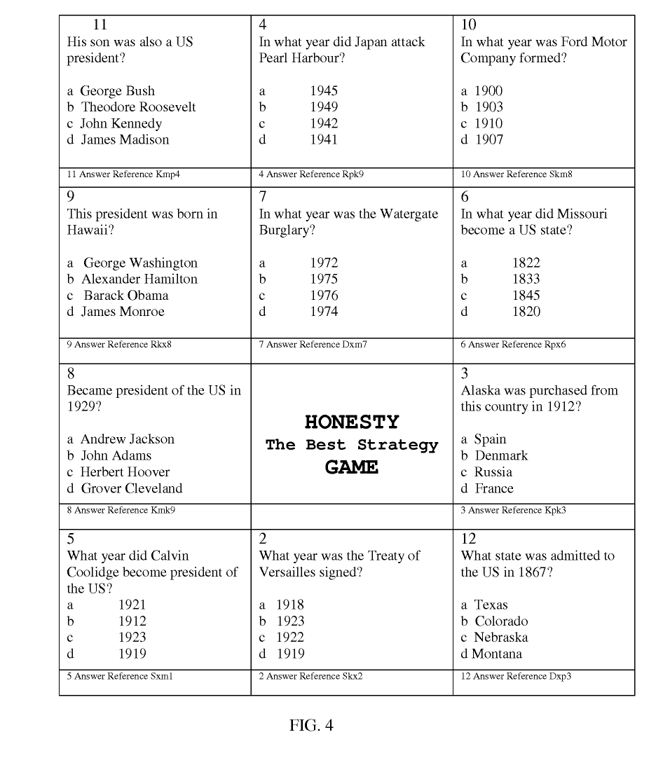

FIG. 2, FIG. 3 and FIG. 4 show plan views of three exemplary question cards, each card containing eleven questions relating to American History. Each of the three cards has the same question card number 1031, showing that they belong to the same set. The notation on the top right of each card 1/20, 2/20 and 3/20 shows the number of that card and that the total set is comprised of twenty question cards.

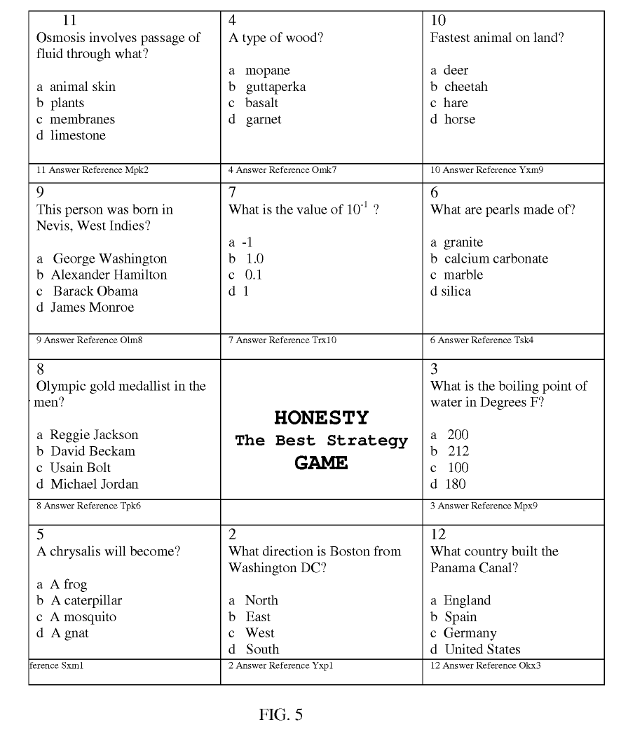

FIG. 5 shows a plan view of one exemplary question card numbered 1010, containing eleven questions relating to General Knowledge. The notation 1/20 on the top right of the question card shows it is card number one in the General Knowledge set of 20.

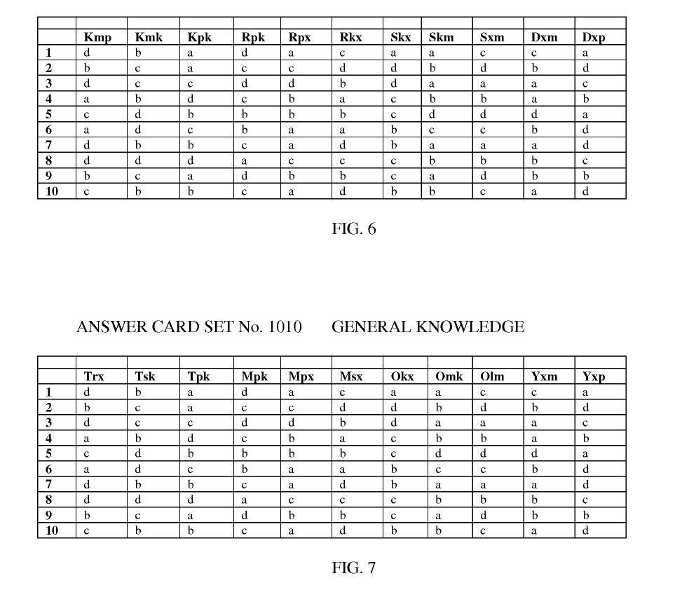

FIG. 6 shows an answer card numbered SET No. 1031 which relates to American History. Using the answer reference below each question on the three question cards shown at FIG. 2, FIG. 3 and FIG. 4 the answers to each question on the three question cards can be located on answer card SET No. 1031. In a similar way the answers to questions on all twenty question cards in the set of question cards relating to American History could be located on the answer card numbered SET No. 1031.

FIG. 7 shows an answer card numbered SET No. 1010 which relates to General Knowledge. As at FIG. 6 the answers to questions on all twenty question cards in the set of question cards relating to General Knowledge could be located on the answer card numbered SET No. 1010.

The answer card is comprised of a matrix with eleven columns and ten rows. Answers to the eleven questions on a question card are not evenly distributed across rows or columns and are placed at random with dummy answers which do not have related answer references or questions, included to discourage memorization. One answer card is used to provide the answers for all questions on each answer card and all answer cards in any one set. A single answer reference is used for each question and is located below the question which allows the players to go directly from the answer reference to the answer. While the use of a single answer reference attempts to make the finding of the answer simple, the letter number combination chosen for the reference is designed to discourage memorization and the device of using one card which also contains dummy answers makes it visually difficult to spot any one answer at a glance.

Two separate answer cards numbered SET No. 1031 and SET No. 1010 are shown at FIG. 6 and FIG. 7 respectively, one for each set of question cards, in order to better illustrate the use of the answer cards, however the game can be played with a single answer card for all sets of question cards or a separate answer card for each set of question cards.

The game features a different leader for each round in which only one question is asked per round. This device allows only one player per round to see the question card containing the questions and the answer reference below each question. The rules do not allow the leader to look at the answer card while being leader. After the leader provides the answer reference another player or a non-player uses the answer reference to locate the answer on the answer card. Consequently there is no opportunity for any one player to see the question and the corresponding answer. Since the question card is unlikely to be used more than once during a game neither the leader nor any other player can benefit from memorising the answer references on the question cards or the answers on the answer cards during the course of any game. In order to discourage memorization the number of question cards used to play the game is unlimited and different sets of questions on different topics can be used interchangeably to play the game.

Players are given answer tokens labelled ‘A’, ‘B’, ‘C’ and ‘D’ to represent each potential answer if the question card provides four potential answers for each question. Since players must provide two answers except as required by the game rules, each player must have access to two sets of tokens.

The spaces on the game board of FIG. 1 are either special spaces or sequential spaces. The special spaces include the four corner spaces and four central side spaces while the sequential spaces are the four remaining spaces on each side of the game board as shown at FIG. 1. The eight special spaces including the start space have indicia which provide directions for the players during the game.

The sequential spaces have indicia which represent four outcomes when a leader accepts help during the game. The four outcomes Honest Abe, Suspicious Sam, Catch A Trickster or We Was Tricked are rewarded with 0, 1, 2 and 3 bonus points respectively. These points represent a rough attempt to capture the different levels of risk attached to the attainment of each outcome. Players whose locations on these spaces coincide with the outcome of the game receive double bonus points which reflect first the level of risk taken and second the exposure associated with being on the space. Strategically it is assumed that players on Suspicious Sam, Catch A Trickster or We Was Tricked spaces will proffer a helping answer that is most likely to produce the outcome which matches their location. However an experienced player might decide that such a simple strategic play would be too obvious. This makes the game interesting and more complex than it may seem initially as it leads to second guessing and attempts to interpret the behaviour and playing style of other players.

Four levels are shown on the game board at FIG. 1. The levels are included for two reasons. First to allow for discussion and information sharing at the start of the game to reduce the disparity between the knowledge and skill of regular players and new players and secondly to include the option of elimination if the players agree, when there are more than two players, which fosters a sense of urgency from the start of the game.

### Description of Play

### Preliminary

The question cards illustrated at FIGS. 2-5, are shuffled. Each player is given 8 answer tokens, 2 labelled A, 2 labelled B, 2 labelled C and 2 labelled D. Players are permitted, if they all agree, to discuss the questions, answers, scoring or game strategy until the first player gets to level 2, but not after. Play begins with the place markers on Start and the place markers move clockwise on the game board illustrated at FIG. 1. Spaces are marked as Honest Abe, Suspicious Sam, Catch A Trickster and We Was Tricked. The other spaces are special spaces and are marked with instructions which must always be followed.

### Rounds

Each question read from a question card taken from the top of the set of question cards provided, is used for 1 round and then placed at the bottom of the set. Each question card contains 11 questions numbered 2 to 12. The question to be read is selected by throwing 2 dice. The sum of the numbers on the 2 dice indicates the number of the question to be read. When each player has proffered an answer for the question and the answers are checked and the scores noted, the round is completed. All question cards and answer cards illustrated at FIG. 6 (to be used, previously used, or in use) should be maintained with the questions and answers not displayed.

### Questions and Answers

Proceeding clockwise each player in turn becomes the leader of 1 round who selects the question (by throw of dice) and reads the question aloud. The first leader is selected by throw of dice and is the player who scores the highest number. The leader starts the timer after reading the question aloud, except when he/she proposes an answer.

Questions have 4 possible answers, A, B, C, or D. Players proffer an answer using an answer token marked A, B, C or D. An answer card with the same number as each of the question cards in a set provides the correct answer to each question on the question cards. An answer reference written below each question on the question card leads to the correct answer on the answer card. To each question all players must proffer an answer, which once proffered cannot be changed. A player who is not the leader should take turns to look up the answer. A person who is not a player or an eliminated player may assist to look up the answers and operate the timer.

### Help

The leader of the round always has the option to refuse help before reading a question aloud. Players must always be willing to provide help and become helpers. All helpers must proffer 2 answers, using the answer tokens as described below, unless a leader refuses help then only one answer is proffered.

Helpers should put their honest answer on their left side and a second strategic answer named a helping answer, which may or may not be correct, on their right. The leader only has 1 answer which is an honest answer. The leader reveals the helping answer tokens only after each helper has proffered 2 answers or time has elapsed.

### Special Spaces

The four corner spaces, except the start space, and the four central spaces on each side of the game board are special spaces. During a round the first player whose marker lands on any one of the four corner spaces, except the start space, which are labelled ‘You Are The Next Leader’ becomes the leader of the next round and the leader who loses his turn as a consequence resumes thereafter.

A player whose marker is on any one of the four central spaces on each side of the game board labelled ‘Leader Proposes Answer’ when that player takes a turn to be the leader, must propose an answer after reading the question. A leader proposes an answer by using his/her answer token to show the answer proposed. The timer is started after the leader proposes an answer. A leader who proposes an answer cannot ask for help.

### Answers not Exposed

After the question is read aloud and all players have proffered their answers with answer tokens turned face down the leader reveals helping answers before honest answers.

If the leader accepts help, the leader first reveals the helping answer tokens, beginning with the helping answer token of the player on the leader's left and then other players continuing to the left. After seeing the helping answers the leader provides his answer token which is not exposed.

If the leader refuses help or accepts help, the leader reveals all answers or honest answers beginning with the answer of the player on the leader's left and then other players continuing to the left. The leader reveals his answer last. After the answer tokens are exposed the leader reads aloud the answer reference below the question which leads to the correct answer on the answer card.

### Points

One point is given to each player who answers a question correctly. The leader of a round gains 1 point if any player fails to proffer an answer within 15 seconds.

Help Bonus Points—If a helper has an incorrect honest answer and the leader has a correct answer, the leader gets 1 bonus point. If a helper has the correct honest answer, the possible outcomes are identified below in both narrative form and tabular form.

### Narrative Form

If a helper has the correct honest answer and;
(i) If a leader is able to identify the helping answer as correct and produces the same answer as his or her answer neither player gets a bonus point.
(ii) If a leader is unable to identify the helping answer as correct and produces a different answer as his or her answer, the helper gets a bonus point.
(iii) If a leader is able to identify the helping answer as incorrect and is able to produce the correct answer instead, the leader gets 2 bonus points.
(iv) If a leader produces the same incorrect answer as the helping answer, the helper gets 3 bonus points.

### Tabular Form

| | Helper's | | | |
|---|---|---|---|---|
| Helper's | Helping | Leader's | Bonus | Description of |
| Honest Answer | Answer | Answer | Points | Outcome |
| Correct | Correct | Correct | 0 | Honest Abe |
| Correct | Correct | Incorrect | Helper-1 | Suspicious Sam |
| Correct | Incorrect | Correct | Leader-2 | Catch a Trickster |
| Correct | Incorrect | Same as | Helper-3 | We was Tricked |
| | | Helper's | | |

### Spaces Bonus Points

A player who is positioned on a Suspicious Sam, Catch A Trickster or We Was Tricked space when the outcome of the game corresponds to that space is awarded double bonus points.

### Special Spaces Bonus Points

A leader whose marker is located on a special space which is one of the four central spaces on each side of the game board who proposes a correct answer gets 2 bonus points for each other player who proffers an incorrect answer. If the leader proposes an incorrect answer each other player who proffers the correct answer gets 2 bonus points.

### Disqualification

A player who fails to proffer an answer within 15 seconds is disqualified for the duration of the game.

### Elimination

At the end of the round after the second player reaches level 4, unless there is already a winner or all players agree otherwise before the game begins, every other player is eliminated leaving only the two players who have reached level 4 to continue. If more than two players have reached level 4, at the end of the round, the players who get there after the first player are tied. A tie is broken by an additional round beginning at the start space between the tied players. The leader of the tiebreaker round is chosen by throw of dice. Points scored in a tiebreaker are only used for the purpose of breaking the tie.

### The Multiplier

The leader of a round at any time after level 1, before selecting a question can seek the option to multiply by 2 the points scored by each player in the round if the multiplier is gained. To gain the multiplier the leader of a round must first state that he/she wishes to gain the multiplier and then get a 6 on 1 or both of the 2 dice thrown to select the question. Once the requirements for the multiplier are satisfied the multiplier is binding. A leader who states that he/she wishes to get the multiplier and does not get a 6 on 1 of the 2 dice proceeds normally without the multiplier.

### The Winner

The game begins at the start space and the winner is the first player to complete a journey around the board ending at the start space.

### By the way

Players with incorrect answers cannot scores any points unless the incorrect answer is a helping answer and the outcome of the game is We Was Tricked or We Didn't Know. A leader who seeks help or proposes an answer, if successful may gain bonus points according to the rules, from one or more players during the round.

### Examples of Points Calculation

A leader on a Catch A Trickster space, when the outcome of the game is Catch A Trickster would gain 1 point for the correct answer, 2 bonus points for the outcome (from at least one helper) and 2 bonus points for being on that space when the outcome corresponds to that same space.

A helper on a We Was Tricked space, when the outcome of the game is We Was Tricked would gain 1 point for the correct answer, 3 bonus points for the outcome from the leader and 3 bonus points for being on that space when the outcome corresponds to that same space.

### For Experienced Players Only—If All Players Agree

Set out below is a fifth outcome when a leader seeks help. It is the We Didn't Know outcome which is a variant of the We Was Tricked outcome. It differs from the We Was Tricked outcome only in respect of the leader having an incorrect answer which is different from the helper's incorrect helping answer.

### Tabular Form

| Helper's | Helper's | | | |
|---|---|---|---|---|
| Honest | Helping | Leader's | Bonus | Description of |
| Answer | Answer | Answer | Points | Outcome |
| Correct | Incorrect | Incorrect and | Helper-1 | We Didn't Know |
| | | different from | | |
| | | helper's incorrect | | |
| | | answer | | |

The We Was Tricked space on the board is also used as the We Didn't Know space. A player whose marker is on the We Was Tricked space gains double bonus points, which in this case means two bonus points, for being on that space if the outcome of the game is We Didn't Know.

1-16. (canceled)

17. A question and answer board game for two or more players, the players playing in successive player turns, said board game comprising:
a plurality of visually distinguishable player place markers, whereby each player is assigned one of said plurality of place markers;
a rectangular game board having four sides, each of the said four sides having a plurality of playing spaces disposed around the periphery of said board, said playing spaces including indicia for directing player action;
said plurality of playing spaces including playing spaces disposed on the periphery of said game board, forming four sides, and said playing spaces including a starting space and additional playing spaces defining a continuous and closed path around the board for advancing said player place markers in a common direction;
a pair of six sided dice, each dice indicating a numerical value from one to six when tossed;
a plurality of sets of answer tokens, each of said sets of answer tokens comprising at least two answer tokens, each answer token having an answer indicating side and an opposing blank side;
a plurality of sets of question cards, each set of question cards comprising at a plurality of question cards relating to a topic, each of the said question cards in a set of question cards having a plurality of questions printed thereon, each question having a corresponding list of at least two potential answers with each potential answer identified by answer-identifying indicia, each of the said questions further being assigned a question number from 2 through 12, whereby a question may be randomly selected by tossing said dice and selecting the question having the corresponding question number;
each of the said questions further having a corresponding answer reference code printed adjacent thereto, said answer reference code consisting of a combination of letters and a number;
at least one answer card having a matrix of answer-identifying indicia arranged in a plurality of columns and rows, each column being identified by a header comprising a combination of letters corresponding to one of said answer reference codes, and said rows being numbered, whereby the correct answer for each question is identified by the answer-identifying indicia found at the intersection of the column having a header matching the combination of letters of the question's answer reference code and the row having the number corresponding to the number of said question's answer code.

18. The board game of claim 17, wherein each of the said sets of question cards have a single corresponding answer card.

19. The board game of claim 17, wherein said plurality of spaces on said game board includes four corner spaces and a plurality of side spaces disposed between each corner space, said plurality of side spaces including at least four centrally positioned side spaces.

20. The board game of claim 19, further including sequential spaces having indicia which represent one of four outcomes during play, and the said four sides of the board corresponding to level 1, level 2, level 3 and level 4 respectively.

21. The board game of claim 20, wherein there are a plurality of spaces between any two adjacent corner spaces with the said four corner spaces, except the start space, and the said centrally positioned spaces on the sides of the board providing a total of at least seven special spaces which bear indicia for directing a player's actions in accordance with the said game rules.

22. The game of claim 21, wherein three of said four corner spaces include indicia indicating that a player landing thereon must become the leader of the next round.

23. A method of playing a question and answer board game by at least two players comprising the steps of:
providing a game set including:
a board having plurality of playing spaces disposed around the periphery of said board, said playing spaces including a starting space;
a plurality of visually distinguishable player place markers;
a pair of six sided dice
a plurality of sets of answer tokens, each of said sets of answer tokens comprising at least two answer tokens, each answer token having an answer indicating side and an opposing blank side;
a plurality of question cards, each set of question card having 11 questions, numbered 2 through 12, thereon, each question having a corresponding plurality of possible answers and an answer reference code;
at least one answer card having indicia thereon, said indicia allowing players to identify correct answers to said questions by using the answer reference code associated with the questions;
engaging in a round of play, each round including the following steps:
(A) selecting one of said question cards;
(B) determining one of the players to be the Leader;
(C) randomly selecting one of said questions from said selected question card by tossing the dice;
(D) indicating whether the Leader is accepting or refusing help;
(E) asking said randomly selected question;
(F) identifying at least one player other than the Leader as a Helper if the Leader indicates he is accepting help;
(G) having each of said identified Helper players proffer two proposed answers to the question using said answer tokens, said two proposed answers including a proposed honest-answer and a proposed helping-answer, wherein said two proposed answers proffered by a player may be the same answers;
(H) awarding each player who correctly answered the question 1 point; and awarding bonus points in accordance with the following:
(i) award 0 bonus points if the Helper's honest-answer and helping-answers are correct and the Leader's answer is correct;
(ii) award the Helper 1 bonus point if the Helper's honest-answer and helping-answer are both correct and the Leader's answer is incorrect;
(iii) award the Leader 2 bonus points if the Helper's honest-answer is correct and helping-answer is incorrect and Leader's answer is correct;
(iv) award the Helper 3 bonus points if the Helper's honest-answer is correct and helping-answer is incorrect and Leader's answer is the same as the Helper's helping-answer;
(I) moving each player place marker around said board according to the number of points awarded each player;
(J) engaging in additional rounds of play by repeating steps A through I; and
(K) identifying as the winner the player who's player place marker first travels completely around said game board.
